(19) United States
(12) Patent Application Publication
(10) Pub. No.: US 2023/0289803 A1
(43) Pub. Date: Sep. 14, 2023

(54) CROSS-NETWORK ASSESSMENT OF TRANSACTIONS FOR PROVIDER REPUTATION

(71) Applicant: MASTERCARD INTERNATIONAL INCORPORATED, Purchase, NY (US)

(72) Inventors: Michael Alan Dewar, Richmond (GB); Jonathan Anastasia, Larchmont, NY (US); Marianne Iannace, Branford, CT (US)

(21) Appl. No.: 17/692,453

(22) Filed: Mar. 11, 2022

(51) Int. Cl. G06Q 20/40; G06Q 40/04

(52) U.S. Cl. CPC G06Q 20/4016; G06Q 40/04

(57) ABSTRACT

A management system for cross-network assessment of transactions for provider reputation receives a provider string associated with a provider identification and that includes a provider score. The provider identification is extracted from the provider string. In view of the provider identification, a potential merchant identification code is determined from a set of known merchant identification codes. At least one transaction associated with the potential merchant identification code can be identified by analyzing transaction data stored in a structured data resource associated with the management system. In view of the provider score, a transaction score is assigned to each transaction associated with the potential merchant identification code. The transaction score is stored. Merchant statistics are determined by analyzing the at least one transaction. A report is generated in view of the merchant statistics and the transaction score. The report is provided for display via a graphical user interface.

### BACKGROUND

Digital currency such as cryptocurrency is becoming more widely accepted as a form of payment for financial transactions. Traditional payment methods used for financial transactions include credit cards, debit cards, or other types of payments. These traditional payment methods typically use fiat currency. Fiat currency is a government-issued currency that is not backed by a physical commodity, such as gold or silver, but rather by the government that issued it. Additionally, digital currency may be purchased or otherwise exchanged/bargained for fiat currency in a financial transaction.

Once a purchase for digital currency is made, the transaction in digital currency is recorded on the blockchain. The digital currency may then be used for various subsequent transactions (or other activities) on the blockchain network. It is possible to use digital currency to make a purchase for goods and services, however, as the transaction occurs on the blockchain network, information regarding the digital currency exchange(s) may not be readily available or traceable using traditional means available to a financial institution. In contrast, transactions completed using traditional payment methods (e.g., payments made using credit cards, bank cards, etc.) are typically traceable by financial institutions such as banks or government agencies in order to prevent fraudulent activity. When exchanges are made on the blockchain (i.e., involving blockchain to blockchain activity), multiple networks may be involved. The blockchain, banking, and payment rail networks share limited or no information regarding the digital currency transactions with one another. Therefore, financial parties such as banks or other institutions may not easily determine risks associated with digital currency transactions, or the reputation of the parties involved in digital currency transactions, especially transactions occurring across different networks.

As digital currencies, such as cryptocurrency, gain wider acceptance in the financial industry, it becomes important for merchants and financial entities to support such digital currency exchange. In addition, since most financial services are regulated with guidelines that include standards such as Know Your Customer, which involves verifying customer identity, suitability, and risks regarding fraud, corruption, money laundering, and the like, it may be important to evaluate risk that takes into account such digital currency exchange transactions.

### BRIEF SUMMARY

Cross-network assessment of transactions for provider reputation is described herein. Provider reputation is useful for entities or institutions such as acquirers, issuers, and banks. Such entities may use provider reputation in order to determine which providers that offer digital currency exchange and which cards used to engage in digital currency exchange are reputable.

Card issuers, acquirers and/or financial institutions (e.g., banks) or services companies may wish to determine a reputation of the providers of digital currency and to determine the reputation of a card and/or a customer that utilizes the card involved in a digital currency transaction. Reputation is important to issuers, acquirers and/or financial institutions (e.g., banks) because these entities can utilize the reputation in order to assess a provider (e.g., to determine if it is a good idea to engage in business with the provider providing digital currency) or one utilizing the card. Such assessment may also be referred to as risk assessment and can be used to determine the amount of digital currency involved in the transaction, determine who the entities involved in the transaction are, as well as determine other information that can be gleaned from the assessment. Providers with a good reputation may be good parties to conduct business with. The reputation of the provider and card may be determined by a management system on a payment network that performs operations including ranking and weighing transactions in order to determine such a reputation used for risk assessment.

system a provider string associated with a provider identification and that includes a provider score. The provider string may be provided by an entity evaluating blockchain risk. The provider identification is extracted by the management system from the provider string. In view of the provider identification, a potential merchant identification code is determined from a set of known merchant identification codes. At least one transaction associated with the potential merchant identification code is identified from analyzing transaction data that may be stored in a structured data resource associated with the management system. In view of the provider score, a transaction score is assigned to each transaction associated with the potential merchant identification code. The transaction score is stored. Merchant statistics are determined by analyzing the at least one transaction. A report is generated in view of the merchant statistics and transaction scores including the transaction score. The report can then be provided for display via a graphical user interface.

There can be many provider strings received by the management system. For example, the management system receives a first provider string associated with a first provider identification and comprising a first provider score. The management system receives a second provider string associated with a second provider identification and comprising a second provider score. The first provider identification is extracted from the first provider string. The second provider identification is extracted from the second provider string. In view of the first provider identification, a first potential merchant identification code is determined from a set of known merchant identification codes. In view of the second provider identification, a second potential merchant identification code is determined from the set of known merchant identification codes. Transaction data stored in a structured data resource associated with the management system is analyzed to identify at least a first transaction associated with the first potential merchant identification code and at least a second transaction associated with the second potential merchant identification code. In view of the first provider score, a first transaction score is assigned to each first transaction. In view of the second provider score, a second transaction score is assigned. The first transaction score and the second transaction score are stored. A report can be generated in view of the first transaction score and the second transaction score. In certain reports, the transaction scores are hierarchically ranked. The report is provided for display via a graphical user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example of an operating environment for payment processing for a digital currency transaction that includes a management system.

FIG. 2 illustrates a high level data flow diagram of a management system providing a reputation manager.

FIG. 3 illustrates an example of a reputation maintenance environment.

FIG. 4A illustrates an example of a report provided for display by a GUI for an acquirer.

FIG. 4B illustrates an example of a report provided for display by a GUI for an issuer.

FIG. 5 illustrates an example process that provides a report generated in view of merchant statistics and a transaction score.

FIG. 6 illustrates an example process that provides transactions scores that are hierarchically ranked.

FIG. 7 illustrates components of a computing system that may be used in certain embodiments described herein.

### DETAILED DESCRIPTION

Cross-network assessment of transactions for provider reputation is described herein. Provider reputation is useful for entities or institutions such as acquirers, issuers, and banks. Such entities may use provider reputation in order to determine the risk associated with providers that provide digital currency exchange and that of the cards used to engage in digital currency exchange. Advantageously, the described systems performing cross-network assessment of transactions for provider reputation are able to map blockchain network risk assessments to appropriate entities known to a payment network and facilitate risk assessment reports used by financial parties such as banks or other institutions to determine risks associated with digital currency transactions.

A “merchant” refers to a provider of goods or services in exchange for payment. The merchant can be physically present at the sale or remote, such as an online retailer.

Virtual Asset Service Providers (“VASPs”) are organizations that provide services related to virtual currency payments. In some implementations, a merchant may be a VASP or otherwise communicate with a VASP in order to obtain virtual currency and provide it to a customer. The described systems and methods utilize the relationship of the purchase of digital/virtual currency using fiat currency to characterize the provider of the digital/virtual currency as a “merchant” (whether or not the provider of the digital/virtual currency is conventionally considered a “merchant” by systems). Conventional transactions that involve banking or payment card rails (of which purchases of digital currency by fiat currency are included) involve standardized message formats, including a merchant field (or a recipient/payee field). Therefore, when transactions are conducted, one identified as a “merchant” may be a provider of digital currency, the reason being that the standardized message format will identify a merchant as one supplying digital currency. Thus, a VASP or an entity providing digital currency, may be identified as or otherwise matched with a “merchant” by the systems described herein, as the VASP provides the digital currency and would be identified as a “merchant” in the standardized message format of the transaction.

A “provider” refers to an entity that provides a good or service, and as described herein, is specifically an entity providing digital currency. Accordingly, in addition to the terms merchant and VASP being used interchangeably (where the VASP is considered by the system as a merchant) and the terms provider and VASP may be used interchangeably; and the terms merchant and provider may also be used interchangeably herein. As described above, a merchant is considered the provider of digital currency (which may be a VASP or a merchant itself).

A “reputation” refers to a trustworthiness associated with providers, cards, and/or transactions. The reputation may be represented in the form of a score or a ranking. Furthermore, the reputation may be used to perform risk assessment.

An “account holding institution (AHI)” refers to a financial institution (e.g., a bank, savings association, credit union, or any other person) that directly or indirectly holds an account belonging to a consumer or customer, or that issues an access device (e.g., bank card or credit card) and agrees with a consumer to provide electronic fund transfer services. In some cases, an AHI may be an issuer. An “issuer” refers to a bank system or other institution that provides payment cards to a holder of a card.

The terms “user,” “customer,” and “consumer” are used interchangeably herein. The term “personal account number” refers to a financial account number, such as, but not limited to, a bank account number, a primary account number (PAN), and a payment card number. The terms “personal account number” and “account number” are used interchangeably herein. The terms “payment” and “transaction” are used interchangeably herein.

Transactions involving digital currencies may include transactions where digital currency is purchased. Payment for the purchase of digital currency may be made using traditional fiat currency payments, including bank transfers and credit cards, or using other types of digital currency. In one example, suppose a customer wishes to purchase digital currency. The customer (either directly or through another party or merchant) may submit payment to a provider such as a VASP to purchase the digital currency. The payment may be in the form of fiat currency. Data surrounding the purchase of digital currency using fiat currency is considered transaction data which may be stored or otherwise made available or accessible by a payment network. Details regarding transaction data are provided herein.

Various parties or entities involved with payment transactions may wish to obtain information regarding transactions both on the payment network and on a blockchain network, including the reputation information about the provider involved in digital currency exchange transactions, in order to calculate risk assessment. Such entities include acquirers, issuers, and banks. Details regarding these entities are described herein.

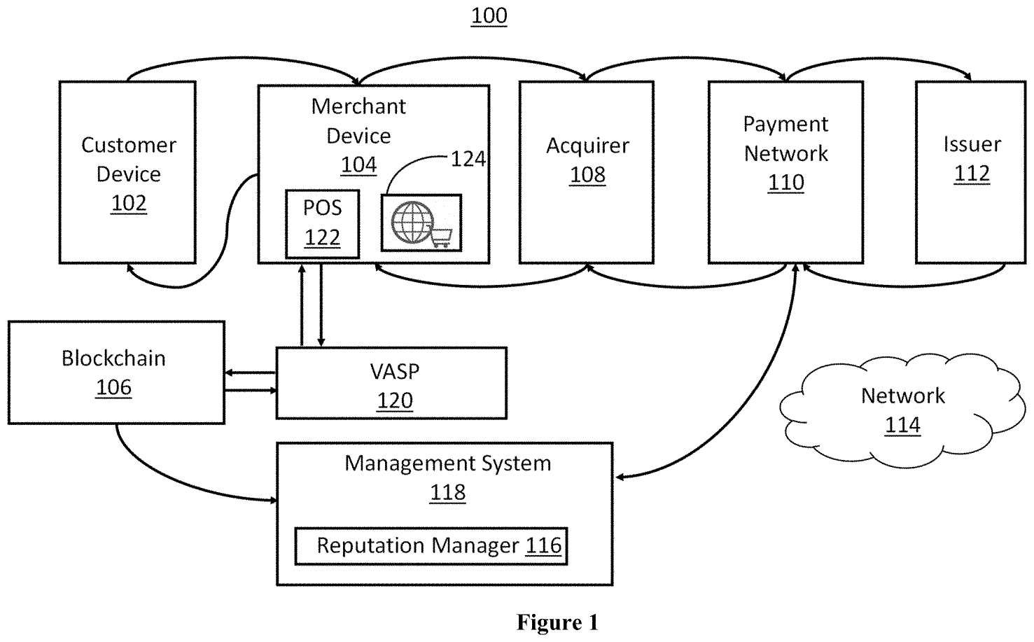

FIG. 1 illustrates an example of an operating environment for payment processing for a digital currency transaction that includes a management system. Referring to FIG. 1, environment 100 includes a customer device 102; a merchant device 104; a blockchain network 106; an acquirer 108; a payment network 110; an issuer 112; and a VASP platform 120. An example of a payment network 110 is the one operated by Mastercard International Incorporated, the assignee of the present disclosure. Environment 100 also includes a network 114 and a management system 118 providing a reputation manager 116. One or more of the depicted components in environment 100 may be connected to one another via network 114.

In one implementation, network 114 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), routers, hubs, switches, server computers, and/or a combination thereof. Communications between components over the network 114 may be based on appropriate protocols and trust mechanisms. Thus, the network 114 may be considered to involve two or more independent networks where different protocols or trust mechanisms are used to communicate between different networks.

The customer device 102 may include one or more computing devices such as personal computers (PCs), laptops, mobile phones, smart phones, tablet computers, netbook computers, etc. The customer device 102 may allow a user operating customer device 102 to view multimedia such as images, videos, web pages, documents, etc. In an implementation, the customer device 102 may include a wallet application.

The merchant device 104 may be similar to the customer device 102 or include more conventional merchant components such as a point of sale terminal 122 or components supporting online commerce (e.g., such as available for an e-commerce platform or a payment application 124), including one or more computing devices (such as a rackmount server, a router computer, a server computer, a personal computer, a mainframe computer, a laptop computer, a tablet computer, a desktop computer, etc.), one or more data stores or one or more structured data resources (e.g., hard disks, memories, databases), networks, software components, hardware components, or combinations thereof.

In an illustrative scenario for a digital currency transaction, suppose that a customer operating, employing or otherwise accessing customer device 102 makes a request from a merchant device 104 to purchase a good or service (referred to as a “transaction”). The customer may provide payment via any fiat currency and/or digital currency (when made available by a financial institution or issuer). Payment may be provided by a credit card, a debit card, a virtual wallet application, etc.

In some implementations, a customer may use a physical payment card to initiate a transaction. However, as used herein, a “payment card” or “card” can also be any non-physical equivalent, such as, for example, a virtual wallet application (also referred to as mobile wallet application) that supports mobile payment via a computing device such as a laptop computer, a mobile device, wearable computing devices (e.g., watch or glasses), and/or similar computing devices. In order to do so, the customer may use an app on a mobile device or other method to initiate the transaction.

The customer, via customer device 102, provides payment and authorization to the merchant device 104 to initiate the transaction for digital currency. The acquirer 108 receives transactions from the merchant device 104 via a payment gateway (e.g., a point of sale (POS) terminal 122 or an online shopping cart or other payment application 124). The acquirer 108 may include a processor that forwards the information regarding the transaction to an appropriate payment network 110. The payment network 110 routes the information regarding the transaction to the appropriate issuer 112, which manages and verifies the payment card information, and routes the authorization from the issuer 112 to the acquirer 108. The payment network 110 can cache the transaction data locally and/or elsewhere. For example, the payment network 110 may transmit a copy of the transaction data to one or more structured data resources, as described herein. When storing the transaction data beyond the time necessary for performing the transaction, it should be understood that any personally identifiable information would be maintained according to appropriate privacy policies and laws, and would not include personal or financial information of customers except that which is permitted (for example by opt-in processes).

The merchant device 104 may complete the transaction via the acquirer 108 in order for the funds to transfer to the merchant's financial institution (not shown in this figure). In some cases, the same entity may be both the payment network and the issuer.

The acquirer 108 may manage a portfolio of merchants independent of where the transactions are initiated. The issuer 112 may manage a portfolio of cards. The VASP platform 120 may manage various digital currency exchanges.

When the customer initiates the purchase of digital currency from the merchant using a fiat payment method, the merchant device 104 may directly (when functioning as a VASP platform 120) or via a separate computing system for VASP platform 120 obtain the digital currency from the blockchain network 106 and provide keys/digital signatures of the digital currency for the customer. As can be seen, because a payment network transaction occurs to purchase digital currency via the VASP platform 120, the VASP is viewed by systems (such as the payment network 110) as the merchant. This is due to the fact that conventional transactions that involve banking or payment card rails involve standardized message formats, including a merchant field (or a recipient/payee field), and thus, the provider of the digital currency is referred to as a merchant.

Although not shown in FIG. 1, in some implementations, instead of using a card, a customer may perform a bank transfer, for example, through a request with a bank via the customer device 102 or by providing associated banking details (e.g., account information that can include account number and sort codes or routing numbers) to the merchant device 104, which then requests an electronic bank transfer on behalf of the customer. The electronic bank transfer may be performed according to any suitable payment clearing system. Example clearing systems include ACH (automated clearing house), Bacs (previously known as Bankers' Automated Clearing System), FPS (faster payments service), and SWIFT (society for worldwide interbank financial telecommunications. Information on the electronic bank transfer transactions may be stored associated with appropriate financial institutions. Here, the VASP is viewed as a recipient/payee of the electronic bank transfer. The bank(s) (not shown) involved in the electronic bank transfers may thus manage a portfolio of bank accounts for payers and payees.

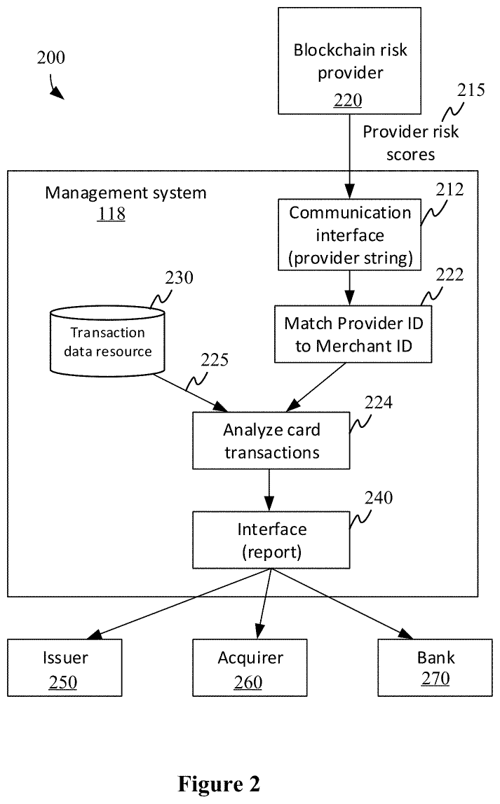

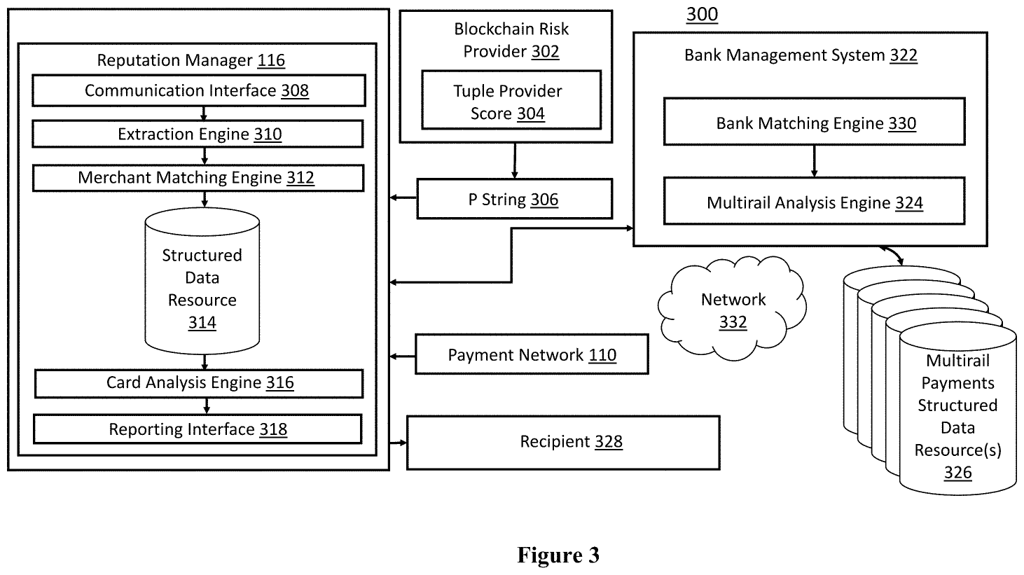

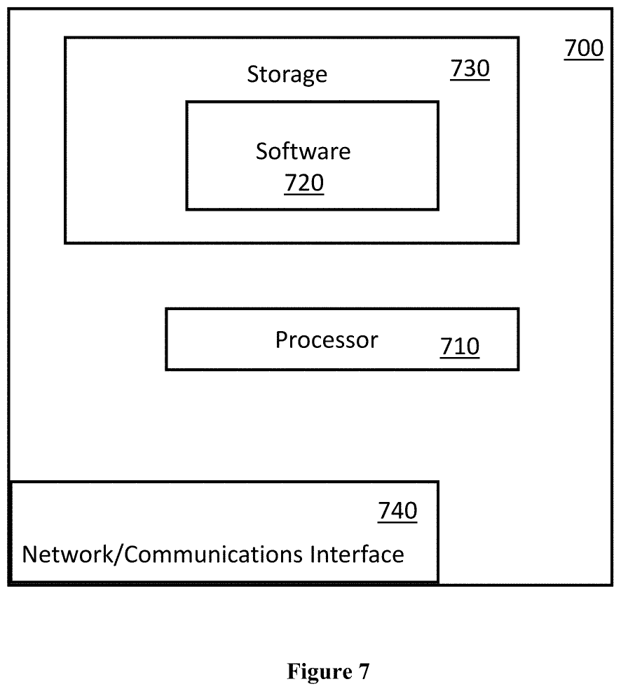

As mentioned above, operating environment 100 further includes the management system 118 providing the reputation manager 116. The reputation manager 116 provides a link between the blockchain network(s) 106 and the payment network 110. Through operations carried out by the management system 118 providing the reputation manager 116, entities on the payment network (e.g., the acquirer 108, the issuer 112, and various financial institutions that are not shown) can obtain information about blockchain transactions. The management system 118 providing the reputation manager 116 may include one or more computing devices (such as a rackmount server, a router computer, a server computer, a personal computer, a mainframe computer, a laptop computer, a tablet computer, a desktop computer, etc.), one or more data stores or one or more structured data resources (e.g., hard disks, memories, databases), networks, software components, hardware components, or combinations thereof that may be suitable for implementing the various features described herein. For example, the management system 118 can be embodied as described with respect to computing system 700 of FIG. 7. In some implementations, the management system 118 providing the reputation manager 116 may communicate with other components not depicted in FIG. 1. For example, the management system 118 providing the reputation manager 116 may communicate with blockchain risk providers, as described in FIGS. 2 and 3; and with financial institutions that perform electronic bank transfers.

Although the depicted implementation shows the management system 118 providing the reputation manager 116 as separate from the payment network 110, the management system 118 providing the reputation manager 116 may be included in or otherwise associated with the payment network 110.

As previously mentioned, details of the transaction (also referred to as transaction data) may be cached or otherwise made available by the payment network 110. The management system 118 providing the reputation manager 116 can access such transaction data from a structured data resource associated with the payment network 110 and/or the management system 118 providing the reputation manager 116. In addition, the management system 118 providing the reputation manager 116 may be able to access information on electronic bank transfer transactions from appropriate entities performing associated multirail payment transactions. In further implementations, other payment systems may also be supported so long as such systems provide transaction information from which a merchant/recipient of fiat currency can be identified.

In an implementation, the management system 118 providing the reputation manager 116 may pull or otherwise receive transaction data from the payment network 110 (and/or various alternate rails or banking payment networks as described above and with respect to FIG. 3) via network 114. The transaction data received by the management system 118 providing the reputation manager 116 from the payment network 110 may include details regarding the “merchant” (which is the provider of the digital currency), the payment method, as well as other details regarding the transaction. The management system 118 providing the reputation manager 116 may store the transaction data in one or more associated structured data resource(s) that the transaction data is used in order to determine provider reputation.

FIG. 2 illustrates a high level data flow diagram of a management system providing a reputation manager. Referring to the data flow diagram 200 shown in FIG. 2, a management system 118 providing a reputation manager 116 (as described with respect to FIG. 1) can receive, via a communication interface 212, provider risk scores 215 from a blockchain risk provider 220.

A provider risk score can include a provider identification, a score of the provider called a provider score, and a set of related provider-level data. This information may be in the form of a string or a vector, called a “P string” as described herein.

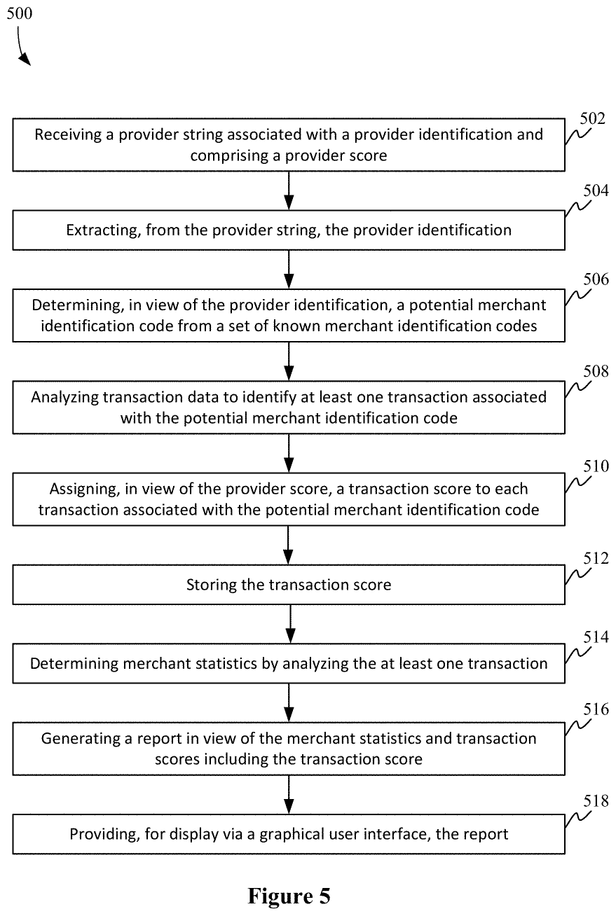

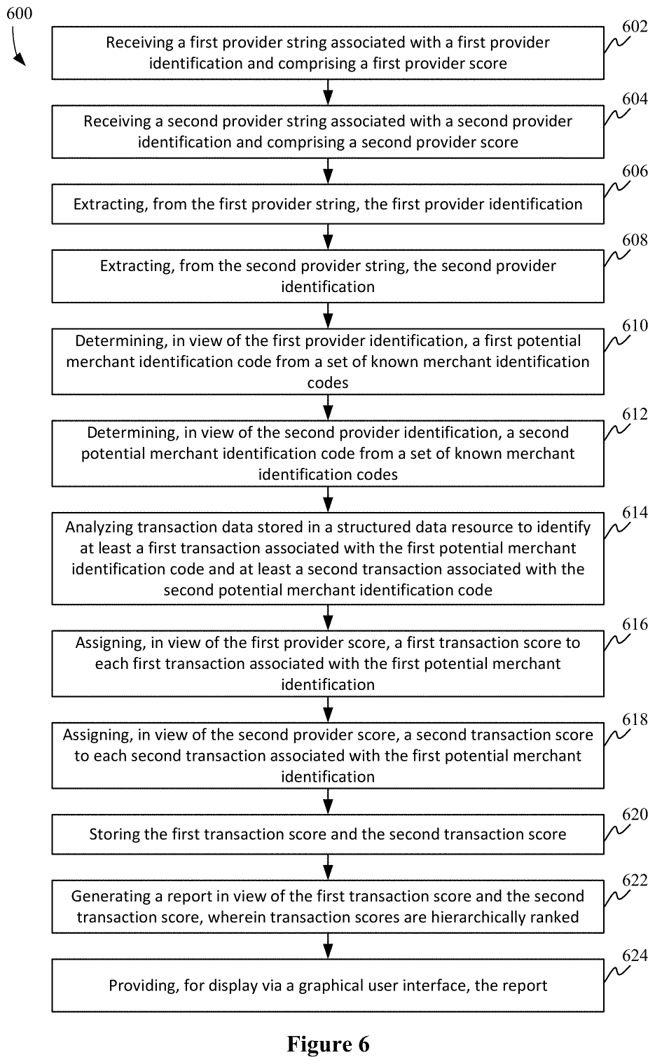

The management system 118 is able to determine a link between the provider risk score 215 which is considered blockchain activity and the transaction data which is considered payment network activity by identifying (222) a best match for the provider identification received in the provider risk score (e.g., from the provider risk scores 215) to known merchant identifiers. Card transactions can be analyzed (224) using the identified best match merchant identifier (from block 222) and the transaction data 225 from the payment network (e.g., payment network 110 of FIG. 1), which may be stored in an appropriate transaction data resource 230. Based on various analysis of the transaction data associated with that merchant identifier, reports can be tailored to appropriate entities. For example, an interface 240 can be provided for communicating tailored reports to issuers 250, acquirers 260, and banks 270. Accordingly, a management system providing a reputation manager is able to use the blockchain activity represented by the provider score received with the provider risk score 215 and the payment network activity represented by the transaction data 225 to calculate and weigh reputation information, analyze, generate, maintain, and report a reputation or risk assessment associated with merchants, cards, and/or transactions. Details of certain processes that can be carried out by management system 118 are described with respect to FIGS. 5 and 6.

An example implementation of a management system 118 providing a reputation manager 116 and reputation maintenance environment is shown in FIG. 3, which can perform the operations shown in the high level data flow of FIG. 2.

FIG. 3 illustrates an example of a reputation maintenance environment. Referring to FIG. 3, reputation maintenance environment 300 includes a blockchain risk provider 302, the management system 118 which includes the reputation manager 116, a recipient 328 (of a report), and a network 332. In some cases, reputation maintenance environment 300 can further include a bank management system 322 and associated multirail payments structured data resource(s) 326 of various distributed multirail data centers or networks. One or more of the depicted components in environment 300 may be connected to one another via network 332.

The reputation manager 116 includes a communication interface 308, an extraction engine 310, a merchant matching engine 312, a structured data resource 314, a card analysis engine 316, and a reporting interface 318. The structured data resource 314 may receive, store, and otherwise make available transaction data associated with various transactions. Reputation manager 116 may be embodied as described with respect to computing system 700 of FIG. 7. For example, extraction engine 310, merchant matching engine 312, card analysis engine 316, and aspects of reporting interface 318 may be implemented as instructions executed by one or more processors.

In one implementation, network 332 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), routers, hubs, switches, server computers, and/or a combination thereof. Communications between components over the network 332 may be based on appropriate protocols and trust mechanisms. Thus, the network 332 may be considered to involve two or more independent networks where different protocols or trust mechanisms are used to communicate between different networks.

The blockchain risk provider 302 receives blockchain activity from the blockchain (not depicted in FIG. 3) and generates a blockchain risk score for various providers. As will be discussed in more detail below, the blockchain risk provider 302 can generate tuple provider scores 304 and provide provider risk scores (i.e., 215 in FIG. 2) in the form of “P strings” 306.

The P string 306 communicated from blockchain risk provider 302 is received by the management system 118 via the communication interface 308. The communication interface 308 may communicate data via a server using Hypertext Transfer Protocol (HTTP) API (in a scheduled manner, for example), or other protocols such as Hypertext Transfer Protocol Secure (HTTPS), File Transfer Protocol (FTP), Secure Shell (SSH) FTP (SFTP), File Transfer Protocol Secure (FTPS), Applicability Statement 2 (AS2), Managed File Transfer (MFT), or other protocols. The transmission from the blockchain risk provider 302 may be submitted using encryption or other security measures. In an implementation, the P string 306 provided to the management system 118 by the blockchain risk provider 302 may involve a one-way outbound directional communication from the blockchain risk provider 302 to the management system 118 providing the reputation manager 116.

P string 306 contains a provider ID, a provider score, and, optionally, a set of related provider or provider-level data. A provider ID may also be referred to as a VASP ID and it represents a provider by a name or an identifier. Examples of provider or provider-level data include, but are not limited to, name, trading—as name, risk scores, know your customer (KYC) scores, bank account details, and business details (e.g., incorporation date, location, officers, number of employees, etc.).

The management system 118 maintains provider reputation by weighting transaction scores in view of the provider score of the P string 306 that is received from the blockchain risk provider 302. However, in order to leverage the provider scores received from the blockchain risk provider 302, the reputation manager 116 uses extraction engine 310 and merchant matching engine 312 to creating a mapping between the provider associated with a provider score and a known merchant.

For example, the extraction engine 310 of the management system 118 providing the reputation manager 116 extracts the provider ID from the P string 306 received via the communication interface 308 and transmits (or otherwise provides) the provider ID to the merchant matching engine 312.

The merchant matching engine 312 attempts to create a potential match between the provider ID and a merchant ID code. Specifically, the merchant matching engine 312 determines, in view of the provider ID, a potential merchant ID code from a set of known merchant ID codes. The set of known merchant ID codes may be from the data stored in structured data resource 314 or may be from another storage resource specifically used to store information on known merchant ID codes. Detailed processes are described with respect to FIGS. 5 and 6.

The structured data resource 314 depicted in FIG. 3 may be the same as or similar to the transaction data resource 230 depicted in FIG. 2 and may be implemented as multiple data resources. Structured data resource 314 can store transaction data from payment network 110. In some cases, the resulting matching of provider ID to potential merchant ID is stored in the structured data resource associated with the appropriate transactions.

It should be understood that any transaction data stored (e.g., by the structured data resource 314 and/or the multirail payments structured data resource(s) 326) or accessed by the management system 118, the bank management system 322, and/or any other entity is maintained according to appropriate privacy policies and laws, and would not include personal or financial information of customers except that which is permitted (for example by opt-in processes). The transaction data can be obtained from systems that process payment transactions, including single message systems, dual message systems, and electronic payment wallet application systems. Some transaction data such as the goods and/or services being sold, can be obtained from an acquirer or issuer when not directly available from the fields in a transaction data message (which is a message used in a transaction).

It should be understood that transaction data may continue to be collected asynchronous to any use of the structured data resource 314.

As described above, the structured data resource 314 may receive and store transaction data associated with various transactions from the payment network 110 and include matched provider information (including provider score of from the corresponding P string 306). The management system 118, via the card analysis engine 316, analyzes the transaction data stored in the structured data resource 314 that is associated with the management system 118 in order to identify at least one transaction that is associated with the potential merchant ID code, assigns a transaction score (which is a value based on the provider score) to each identified transaction associated with the potential merchant ID code, and performs merchant statistics (which includes analysis of transactions of a particular merchant and analysis of transactions of a particular payment card with one or more merchants).

The management system 118, for example via reporting interface 318, generates a report in view of the merchant statistics (determined in view of payment network activity) and the transaction score (determined in view of blockchain activity from the provider score). A report may be generated based on the recipient 328. For example, different, customized reports may be generated for the following recipients: acquirers, issuers, and/or banks. An acquirer's report may include information about inbound transactions (from the perspective of the acquirer) and transaction scores of providers of digital currency. An issuer's report may include outbound payments (from the perspective of the issuer) made via card payments or bank payments (by the customer) to merchants and risk or scores associated with cards. A bank's report may include both types of information that is of importance to an acquirer and an issuer.

The management system 118 provides, for display via a graphical user interface (GUI), the report. The reporting interface 318 of the management system 118 can provide the report to acquirers, issuers, or banks and the reports may be displayed via a GUI.

The reporting interface 318 may provide access to the report via push or pull communications. For example, access to the report (e.g., as a pull communication) can be made available via an API.

Multirail Specific Implementation

As mentioned above, payment for a digital currency may be made outside of the payment network 110 and therefore the transaction data is not directly available from the payment network 110, but instead is available at an appropriate multirail structured data resource (e.g., of the multirail structured data resources 326). As illustrated in FIG. 3, to incorporate transaction data (from a digital currency transaction) from electronic bank transfers, the environment 300 includes the bank management system 322 which includes a bank matching engine 330 and a multirail analysis engine 324. The bank management system 322 receives provider information (and other elements of the P string 306) from the extraction engine 310 of the management system 118, identifies a corresponding provider bank account(s), via the bank matching engine 330, and communicates with various resources on banking/multirail networks to obtain information on multirail transactions for analysis by the multirail analysis engine 324. The multirail payments structured data resource(s) 326 may store and maintain the electronic bank transfer transaction data including the bank account information for providers of digital currency.

Accordingly, as a high level data flow, in the multirail specific implementation, the management system 118, via the communication interface 308, receives the P string 306; and the extraction engine 310 extracts the provider ID from the P string 306. When the provider ID includes bank account information, the bank management system 322 is used. For example, the extraction engine 310 of the management system 118 extracts the provider ID and transmits the provider ID (including the bank account information) to the bank matching engine 330 along with the other elements of the P string 306.

The bank matching engine 330 of the bank management system 322 matches the provider ID with bank account information. The bank account information may include sorting or routing codes and account numbers of providers.

The bank management system 322, via the multirail analysis engine 324, analyzes the electronic banking transaction data stored in one or more of the multirail payments structured data resource(s) 326 in order to identify at least one transaction that is associated with the identified provider's bank account. Various analysis can be carried out similar to that described with respect to card analysis engine 316 (subject to the differences between the fields available for transaction data on a payment network and the fields available for electronic banking transfers on a banking network). Results of the analysis can be provided to the reputation manager 116 of the management system 118 for combining with the results of the card analysis engine 316 and used in generating reports.

Reports

As described above with respect to FIG. 3, the recipient 328 may be one or more of an acquirer, issuer, and/or bank. Reports provided may be customized for each recipient or each type of recipient.

For an acquirer, providers (such as VASPs) which may or may not be merchants associated with the acquirer may be of importance. Specifically, inbound transactions to the acquirer (from the perspective of the acquirer) may be of importance to the acquirer. As described above, an acquirer receives payments submitted on behalf a customer for a merchant, and therefore, from the perspective of the acquirer, such payments are considered inbound transactions.

In an implementation, the acquirer's objective may be to weigh transaction scores for providers that they process transactions for. Therefore, an acquirer may be concerned about the reputation and/or risk of the funds that are received by merchants for payment made by the customers as well as the reputation of the VASP (where the merchant is considered to be the VASP who provides the digital currency). The acquirer may use the report to determine risk with respect to merchants and/or VASPs.

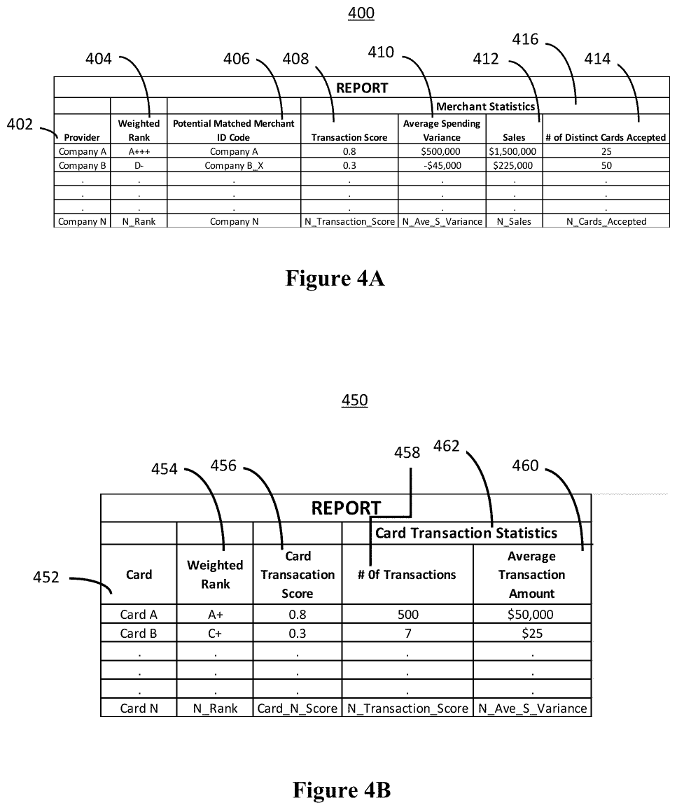

FIG. 4A illustrates an example of a report provided for display by a GUI for an acquirer. A report 400 may be provided by the reporting interface 318 described with respect to FIG. 3. The report 400 may include various columns including the depicted columns, or more or fewer columns than depicted.

The report 400 includes a provider column 402, a weighted rank column 404, a potential matched merchant ID code column 406, a transaction score column 408, an average spending variance column 410, a sales column 412, and a # of distinct cards accepted column 414. The transaction score column 408, the average spending variance column 410, the sales column 412, and the # of distinct cards accepted column 414 may be sub-columns within a merchant statistics column heading 416.

The report 400 may be used by an acquirer to view relevant information to determine a risk associated with its various merchants. The weighted rank column 404 may contain a calculated ranking of a corresponding merchant. Any weighing scheme may be used to determine the ranking. In the depicted implementation, Company A is ranked “A+++” which is a hierarchically greater weighted ranking than Company B's “D-” ranking. The ranking may be based on the columns depicted or on other criteria.

For an issuer, funds used to complete transactions (from cards issued by the issuer) being transmitted from customers to merchants may be of importance. Specifically, outbound transactions from the issuer (from the perspective of the issuer) may be of importance.

In an implementation, the issuer's objective may be to identify and weigh transaction data associated with cards issued by the issuer, where a merchant is selling digital currency or other digital assets in exchange fiat currency (via payment cards, etc.). Therefore, an issuer may be concerned about the reputation and/or risk affecting the funds that are being sent from a customer to the merchant. The issuer may use the report to determine risk with respect to cards issued by the issuer and transactions that are made using those cards. Thus, the issuer may be concerned with relevant card transactions that are made by a holder of the card.

FIG. 4B illustrates an example of a report provided for display by a GUI for an issuer. A report 450 may be provided by the reporting interface 318 described with respect to FIG. 3. The report 450 may include various columns including the depicted columns, or more or fewer columns than depicted.

The report 450 includes a card column 452, a weighted rank column 454, a card transaction score column 456, a # of transactions column 458, and an average transaction amount column 460. The # of transactions column 458 and the average transaction amount column 460 may be sub-columns within a card transaction statistics column heading 462.

The report 450 may be used by an issuer to view relevant card information to determine a risk associated with various cards. The weighted rank column 454 may contain a calculated ranking of a corresponding card. Any weighing scheme may be used to determine the ranking. In the depicted implementation, card A is ranked “A+” which is a hierarchically greater weighted ranking than card B's “C+” ranking. The ranking may be based on the columns depicted or on other criteria.

In yet another implementation, a bank may be the recipient 328 in FIG. 3. A bank may wish to assess risk with respect to providers that hold an account at that bank. A report similar to that of FIG. 4B may be provided. Of course, more or fewer columns may be provided with relevant information.

FIG. 5 illustrates an example process that provides a report generated in view of merchant statistics and a transaction score. Process 500 may be carried out by the management system 118. Referring to FIG. 5, the process 500 includes receiving (502) at a management system, a provider string associated with a provider identification and comprising a provider score.

The management system 118 receives the provider string (e.g., P_string 306) associated with a provider identification and comprising a provider score from the blockchain risk provider 302 (which is obtained from the blockchain activity). The provider string may be transmitted from the blockchain risk provider 302 to the management system 118 providing the reputation manager 116 via the network 332 in FIG. 3.

For example, in an implementation, suppose that a provider such as a VASP is represented by the variable “P”. P may be characterized by a data set. Examples of the data set may include P's name (i.e., a registered name, a legal name recognized by a government entity), P's trading name (i.e., a name that identifies P in its industry, an official name under which P conducts business, a “doing business as” (“DBA”) name, etc.), P's bank account details (ACH, SWIFT code, routing number, account number or partial account number), P's known directors, etc. Such information may also be referred to as provider identification and the provider identification may include additional elements described herein. All pertinent information regarding P may be represented by a set of provider strings and is represented by “x_P”:

x_P={x1,x2, . . . xn},

where “x” is an individual provider string associated with P, and there may be 1, 2, . . . , n total “x” strings.

The set of provider strings for P, represented by “x_P”, are associated with a provider score, represented by “y”. The provider score may be scored according to any scale. In one implementation, the provider score “y” may range between 0 and 1, where 0 represents the lowest score and 1 represents the highest score. The provider score “y” may be generated or otherwise obtained by the blockchain risk provider 302 in any of a number of ways.

The blockchain risk provider 302 can use “y” (and other variables) to generate a collection of “Z” of tuples called the tuple provider score 304. The tuple provider score 304 may be collated as a collection “Z” of tuples as follows:

Z=[(x,y)_P1(x,y)_P2 . . . (x,y)N],

where N is a number of scored providers (or VASPs).

“Z” may be arranged in any format. In one implementation, “Z” may be arranged in a serialized fashion as Comma-Separated Values (csv) with one tuple per line. “Z” or the tuple provider score 304 may include one or more “Z” of tuples. The formatted “Z” of tuples for a provider may be converted by the blockchain risk provider 302 into a provider string, vector, or a file called a P string 306.

Returning to FIG. 5, the process 500 includes extracting (504), from the provider string, the provider identification. For example, based on the receipt of a provider string generated from a Z tuple as described above, the management system 118, via the extraction engine 310, extracts from the provider string (P string 306) the provider ID.

The process 500 then includes determining (506), in view of the provider identification, a potential merchant identification code from a set of known merchant identification codes. For example, the management system 118 determines, in view of the provider ID, a potential merchant ID code from set of known merchant identification codes. The codes may be stored in a structured data resource in the form of a merchant table. The identification/matching may be performed by merchant matching engine 312 of the management system 118.

The merchant matching engine 312 may perform the attempted matching using any method. For example, the merchant matching engine 312 may try to match the provider ID (extracted from blockchain activity) with a set of known merchant ID codes (extracted from payment network activity) stored in a hierarchy table. If an exact match is not possible, a closest match may be made. In an implementation, string and natural language processing techniques may be implemented in order to determine the best potential match. For example, a provider ID may be “Company Abcd Corporations”. The merchant matching engine 312 may determine the that the closet match stored in the set of merchant ID codes corresponds to “Company Abcd Corporation”.

Additionally, error-correcting techniques such as using a machine learning classifier to handle difficult cases may be implemented in order to determine the potential merchant ID code. Typographical type errors may prohibit matching and thus, these techniques may be utilized to perform the matching. A distance function may also be used to match a set of strings (represented by “x_P”) to a merchant ID code (represented by “E_d”). Thus, the distance function may be used to determine the distance between x_P and E_d in order to perform approximate string matching to find a closest match.

In an implementation, a potential match may be made that best matches (i.e., highest probable match of) a provider ID with a known merchant ID code.

In some cases, the transaction data stored in the structured data resource includes one or more fields corresponding to the provider risk score information (including one or more of provider identification and provider score) and the one or more fields are updated with the results of the matching process so that transactions associated with a particular merchant include the provider information.

A provider ID (and corresponding known merchant ID) may be associated with multiple entities. The merchant matching engine 312 may use association rules appropriate to the structured data resource 314 to expand a merchant ID code, E_d, to a broader set of entities that are known to be owned by the matched entity that is associated with the potential merchant ID code. For example, a specific provider may be identified with an International Bank Account Number (IBAN). By leveraging certain resources, other IBANs can be identified that are owned by the same legal entity as the matched entity/merchant associated with the one merchant ID, and these accounts can be grouped and evaluated together by the card analysis engine 316.

The process 500 includes analyzing (508) transaction data stored in a structured data resource associated with the management system to identify at least one transaction associated with the potential merchant identification code. For example, the management system 118 can identify at least one transaction that is associated with the potential merchant ID code in the transaction data structured data resource 314.

The process 500 includes assigning (510), in view of the provider score, a transaction score to each transaction associated with the potential merchant identification code. In some cases, the transaction score is the provider score. However, other values representing the provider score may be used.

The transaction score may be represented by any scale. In one implementation, a high risk transaction score may be indicated of a high risk associated with the transaction whereas a low risk transaction score may be indicative of a low risk associated with the transaction. In an implementation, a high risk transaction score may be indicative of a high risk provider that engages in risky or otherwise illegal activities such as gambling, fraud, money laundering, illicit behavior, terrorism, arms trafficking, drug trafficking, etc. A low risk transaction score may be indicative of a low risk provider such as one that is required by law to provide reporting to a government authority.

The process 500 includes storing (512) the transaction score. The transaction score can be stored associated with each transaction associated with the potential merchant identification code. The transaction score may be stored within a structured data resource. In some cases, the transaction score is stored associated with/mapped to the corresponding transaction data in a structured data resource such as structured data resource 314 of FIG. 3.

The process 500 determines (514) merchant statistics by analyzing the at least one transaction. The management system 118 determines merchant statistics by analyzing the at least one transaction. Specifically, the card analysis engine 316 of the management system 118 may perform the analysis.

Since a plurality of provider strings can be received by the management system, the extracting of provider identification, the identifying potential merchant, identifying transactions associated with the identified potential merchant, and assigning and storing of transaction score can be performed for each provider string that is received. The determination of merchant statistics can thus be made over a plurality of transactions having various associated transaction scores based on the received provider scores.

Transaction data (such as stored in a structured data resource 314) of the at least one transaction may include, at a minimum, at least two transaction attributes. Transaction attributes of the transaction data can include, but are not limited to, a merchant ID (e.g., a merchant's name or other identifying information), a masked user ID (e.g., a masked card number or other value or string used to distinguish between users but not reveal actual user information), a value (e.g., an amount of money), currency, a payment method (e.g., virtual wallet/digital payment, particular card product payment such as Mastercard, Visa, American Express, payment type such as credit, debit, pre-paid, etc.), a time and date, and the goods and/or services being sold in exchange for the value, as well as other information. In some cases, the transaction attributes are any transaction attributes available according to one or more standards (e.g., ISO).

Examples of merchant statistics include average spending variance associated with the potential merchant ID code, which is the difference between the actual amount of a particular expense and the expected (or budgeted) amount of an expense for a merchant, generated sales, projected sales, a number of distinct cards/types of payments accepted by the merchant corresponding to the potential merchant ID code, etc. The merchant statistics may be determined based on transaction data. Examples of merchant statistics include, but are not limited to, inbound volumes, transaction rates, transaction dynamics, transaction trends, normal value and volume distributions, number of bank accounts/PANs, and value/volume/ratios/benchmarking of crypto transactions.

When determining merchant statistics, the management system 118 may isolate the transactions to, from, or through each merchant ID over a specific set of time windows, producing a set of transactions T_X=[t1, t2, . . . tW], where tk (k=1 to W) is an individual transaction associated with a merchant ID code, E_d, and W is the number of transactions in the window. The management system 118 may aggregate multiple transactions to generate a set of merchant statistics, represented by θ_E_d.

Accordingly, the process 500 can include generating (516) a report in view of the merchant statistics and the transaction scores. The management system 118 generates the report in view of the merchant statistics and the transaction score.

For example, referring again to the set of provider strings for P (x_P), reports generated for entities (issuers, acquirers and/or banks) may be based on various goals of an entity. In an implementation, issuers and acquirers may wish to obtain reports in order to calculate a distance between the supplied set of strings x_P associated with a provider and all the entities included in a merchant table that includes set of known merchant ID codes. The distance is used to determine a best (closest) match. String and natural language processing may be used by in order to find a best match. Additionally, error-correcting techniques such using a machine learning classifier to handle difficult cases where potential matches are not easily made may be used.

For bank accounts, the set of strings x_P may be expected to contain a unique identifier (e.g., an IBAN).

When isolating a window of transactions, for aggregation for issuers, outbound transactions from cards to merchants may be reviewed. For aggregation for acquirers, the window of transactions of interest may be across issuers, terminating at a particular set of merchants, and inbound transactions from cards terminating at merchants may be reviewed. For banks, this transaction flows both to and from accounts associated with providers are reviewed.

The process 500 includes providing (518), for display via a graphical user interface (GUI), the report. The reporting interface 318 can provide the report for display via a GUI (and may be used to tailor specific reports that are being generated).

When providing the report, the management system 118 may provide the merchant ID code (represented by “E_d”), the provider score (represented by “y_P”), and the set of merchant statistics (represented by “θ_E_d”) and make them available via the reporting interface 318, indexed by the merchant ID code, E_d. The management system 118 may generate a map as follows: E_d: (y_P, θ_E_d) and the map may be available as a database table or can be transferred via an interface such as an application programming interface (API).

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of HTTP request messages and a specified format or structure for response messages according to a REST (Representational State Transfer) or SOAP (Simple Object Access Protocol) architecture.

In some cases, the report can be sent by a push service. The management system 118 can identify one or more recipients of a particular type of report; and send, to each identified recipient (i.e., acquirer, issuer, or bank) of the one or more recipients, corresponding reports via the push service. In some cases, the recipients are registered subscribers for the report.

The identified recipient may wish to receive the report as a web-based GUI. The GUI's backend server may maintain the state E_d: (y_P, θ_E_d) such that the providers that are identified in a particular context are represented by E_d, the provider score associated with that provider is represented by y_P, and the statistics relevant to the provider in that context are represented by θ_E_d. The recipient may retrieve this state regularly from the reporting interface 318 on any on-demand or on a timed scheduled basis.

The GUI's front-end may retrieve the appropriate subset of the state for the authorized recipient, and present it using an appropriate set of multimedia, data visualizations and interactive elements.

Accordingly, in an implementation of process 500, the provider string is a vector comprising the provider identification, the provider score, and a set of related provider-level data, and wherein the management system 118 receives a plurality of provider strings. In an implementation, each of the plurality of provider strings are arranged in tuples in comma-separated values format in the structured data resource.

In an implementation, process 500 determines (506) the potential merchant identification code from a set of known merchant identification codes using at least one of string and natural language processing techniques, or error-correcting techniques such as using a machine learning classifier.

In an implementation, the transaction data comprises at least one of a plurality of merchant identification codes, a plurality of masked card numbers, or a plurality of payment methods.

In an implementation, the merchant statistics comprise at least one of an average spend variance associated with the potential merchant identification code, generated sales, projected sales, or a number of distinct cards or types of payments accepted by a merchant associated with the potential merchant identification code.

In an implementation, the management system 118 receives the provider string from a blockchain risk provider.

FIG. 6 illustrates an example process that provides transactions scores that are hierarchically ranked. Process 600 may be carried out by the management system 118. There can be many provider strings received by the management system. Referring to FIG. 6, the process 600 includes receiving (602) at a management system, a first provider string associated with a first provider identification and comprising a first provider score.

The management system 118 receives a first provider string (P string 306) associated with a first provider identification and comprising a first provider score from the blockchain risk provider 302.

The process 600 includes receiving (604) a second provider string associated with a second provider identification and comprising a second provider score.

The management system 118 receives a second provider string (P_string 306) associated with a second provider identification and comprising a second provider score from the blockchain risk provider 302. The first and second provider strings may be generated based on two separate transactions; one transaction completed by a first merchant and a second transaction completed by a second merchant.

The process 600 includes extracting (606), from the first provider string, the first provider identification. The management system 118 extracts from the first provider string (P_string 306), the first provider ID. Specifically, the extraction engine 310 of the management system 118 extracts from the first provider string, the first provider ID.

The process 600 includes extracting (608) from the second provider string, the second provider identification. The management system 118 extracts from the second provider string (P_string 306), the second provider ID. Specifically, the extraction engine 310 of the management system 118 extracts from the second provider string, the second provider ID.

The process 600 includes determining (610), in view of the first provider identification, a first potential merchant identification code from a set of known merchant identification codes. The management system 118 determines, in view of the first provider ID, a first potential merchant ID code from a set of known merchant identification codes. The codes may be stored in a structured data resource in the form of a merchant table.

The process 600 includes determining (612), in view of the second provider identification, a second potential merchant identification code from the set of known merchant identification codes. The management system 118 determines, in view of the second provider ID, a second potential merchant ID code from the set of known merchant identification codes. The codes may be stored in one or more structured data resources in the form of a merchant table.

The process 600 includes analyzing (614) transaction data stored in a structured data resource associated with the management system 118 to identify at least a first transaction associated with the first potential merchant identification code and at least a second transaction associated with the second potential merchant identification code. The management system 118 analyzes transaction data that is stored in structured data resource 314 associated with the management system 118 to identify at least a first transaction that is associated with the first potential merchant ID code and at least a second transaction associated with the second potential merchant ID code. The identification/matching may be performed by merchant matching engine 312.

The process 600 includes assigning (616), in view of the first provider score, a first transaction score, wherein the first transaction score is associated with the at least first transaction associated with the first potential merchant identification code. The management system 118 assigns a first transaction score in view of the first provider score. The first transaction score is associated with at least the first transaction associated with the first potential merchant identification code.

The process 600 includes assigning (618), in view of the second provider score, a second transaction score, wherein the second transaction score is associated with the at least second transaction associated with the second potential merchant identification code. The management system 118 assigns a second transaction score in view of the second provider score. The second transaction score is associated with the at least second transaction associated with the second potential merchant identification code.

The process 600 includes storing (620) the first transaction score and the second transaction score. The transaction score may be stored within a structured data resource and the transactions scores are hierarchically ranked.

The process 600 includes generating (622) a report in view of the first transaction score and the second transaction score, wherein transactions scores are hierarchically ranked. The management system 118 generates the report in view of the first transaction score and the second transaction score. For example, as depicted in FIG. 4A, Company A has a transaction score of 0.8 and Company B has a transaction score of 0.3. The weighted rank of Company A is ranked hierarchically greater than that of Company B.

The process 600 includes providing (624), for display via a graphical user interface, the report. For example, the reporting interface 318 provides the report for display via a GUI.

In an implementation, the report is provided via an API. Customized reports may be provided via the API to issuers, acquirers, and/or banks.

In an implementation, the first and second provider strings are corresponding vectors where each vector comprises the provider identification, the provider score, and a set of related provider-level data. The management system 118 receives a plurality of provider strings.

In an implementation, the plurality of provider string is arranged in tuples in comma-separated values format in the structured data resource.

In an implementation, at least one of the first potential merchant identification code or the second potential merchant identification code are determined from the set of known merchant identification codes using at least one of string and natural language processing techniques, or error-correcting techniques such as using a machine learning classifier.

In an implementation, the transaction data comprises at least one of a plurality of merchant identification codes, a plurality of masked card numbers, or a plurality of payment methods.

In some implementations, reports may be provided to recipients via push or pull methods or automatically based on timed intervals. For example, reports may be provided to acquirers on a daily basis. In other implementations, reports may be provided in real-time fashion (e.g., upon completion of a transaction). Additionally, transaction data may be provided in a scheduled manner to various structured data resources.

FIG. 7 illustrates components of a computing system that may be used in certain embodiments described herein. Referring to FIG. 7, system 700 may be implemented within a single computing device or distributed across multiple computing devices or sub-systems that cooperate in executing program instructions. The system 700 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 700 can include a processing system 710, which may include one or more processors and/or other circuitry that retrieves and executes software 720 from storage system 730. Processing system 710 may be implemented within a single processing device but may also be distributed across multiple processing devices or sub-systems that cooperate in executing program instructions.

Storage system(s) 730 can include any computer readable storage media readable by processing system 710 and capable of storing software 720. Storage system 730 may be implemented as a single storage device but may also be implemented across multiple storage devices or sub-systems co-located or distributed relative to each other. Storage system 730 may include additional elements, such as a controller, capable of communicating with processing system 710. Storage system 730 may also include storage devices and/or sub-systems on which data is stored. System 700 may access one or more storage resources in order to access information to carry out any of the processes indicated by software 720.

Software 720, including routines for performing processes such as processes 500 and 600 for the management system may be implemented in program instructions and among other functions may, when executed by system 700 in general or processing system 710 in particular, direct the system 700 or processing system 710 to operate as described herein.

In implementations where the system 700 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 740 may be included, providing communication connections and devices that allow for communication between system 700 and other computing systems (not shown) over a communication network or collection of networks (not shown) or the air.

In some embodiments, system 700 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Any function applying to the reputation manager 116 may equally apply to the management system 118. Although the management system 118 is depicted as including the reputation manager 116, in other implementations, the management system 118 and reputation manager 116 may be separate and communicate with each other using network communication methods. Additionally, any entity represented in a singular format may also be equally represented in plural format and vice versa. Although exemplary entities are described, in other implementations, more or less entities than described may be used to achieve the goals of the disclosure.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method comprising:
receiving, at a management system on a payment network, a provider string associated with a provider identification and comprising a provider score with respect to activity of a provider on a second network, wherein the second network is a separate network from the payment network;
extracting, from the provider string, the provider identification;
determining, in view of the provider identification, a potential merchant identification code from a set of known merchant identification codes within the payment network that corresponds to the provider;
analyzing transaction data stored in a structured data resource associated with the management system to identify at least one transaction associated with the potential merchant identification code;
assigning, in view of the provider score of the provider used to determine the potential merchant identification code, a transaction score to each transaction associated with the potential merchant identification code to incorporate the provider score with respect to the activity of the provider on the second network;
storing the transaction score;
determining merchant statistics by analyzing the at least one transaction;
generating a report in view of the merchant statistics and transaction scores including the transaction score which incorporates the provider score with respect to the activity of the provider on the second network with transaction data on the payment network; and
providing, for display via a graphical user interface, the report.

2. The method of claim 1, wherein the provider string is a vector comprising the provider identification, the provider score, and a set of related provider-level data, and wherein the management system receives a plurality of provider strings.

3. The method of claim 2, wherein the plurality of provider strings is arranged in tuples in comma-separated values format in the structured data resource.

4. The method of claim 1, wherein the determining of the potential merchant identification code comprises using at least one of string and natural language processing techniques, or error-correcting techniques.

5. The method of claim 1, wherein the transaction data comprises at least one of a plurality of merchant identification codes, a plurality of masked card numbers, or a plurality of payment methods.

6. The method of claim 1, wherein the merchant statistics comprise at least one of an average spend variance associated with the potential merchant identification code, generated sales, projected sales, or a number of distinct cards or types of payments accepted by a merchant associated with the potential merchant identification code.

7. The method of claim 1, wherein the second network is a blockchain network, wherein the management system receives the provider string from a blockchain risk provider.

8. One or more computer-readable storage media having instructions stored thereon that when executed by a processing system, direct the processing system to:
receive, at a management system on a payment network, a first provider string associated with a first provider identification and comprising a first provider score with respect to activity of a first provider on a second network, wherein the second network is a separate network from the payment network;
receive a second provider string associated with a second provider identification and comprising a second provider score with respect to activity of a second provider on a third network, wherein the third network is a separate network from the payment network and the second network;
extract, from the first provider string, the first provider identification;
extract, from the second provider string, the second provider identification;
determine, in view of the first provider identification, a first potential merchant identification code from a set of known merchant identification codes;
determine, in view of the second provider identification, a second potential merchant identification code from the set of known merchant identification codes;
analyze transaction data stored in a structured data resource associated with the management system to identify at least a first transaction associated with the first potential merchant identification code and at least a second transaction associated with the second potential merchant identification code;
assign, in view of the first provider score of the first provider used to determine the first potential merchant identification code, a first transaction score to each first transaction associated with the first potential merchant identification code to incorporate the first provider score with respect to the activity of the first provider on the second network;
assign, in view of the second provider score of the second provider used to determine the second potential merchant identification code, a second transaction score to each second transaction associated with the second potential merchant identification code to incorporate the second provider score with respect to the activity of the second provider on the third network;
store the first transaction score and the second transaction score;
generate a report in view of the first transaction score and the second transaction score which incorporates the first provider score with respect to the activity of the first provider on the second network and the second provider score with respect to the activity of the second provider on the third network with transaction data on the payment network, wherein transactions scores are hierarchically ranked; and
provide, for display via a graphical user interface, the report.

9. The media of claim 8, wherein the report is provided via an application programming interface (API).

10. The media of claim 8, wherein the first and second provider strings are corresponding vectors, each vector comprising the provider identification, the provider score, and a set of related provider-level data, and wherein the management system receives a plurality of provider strings.

11-13. (canceled)

14. A computing device comprising:
a processor;
a storage device; and
a reputation manager having instructions to maintain a provider score, the instructions stored in the storage device that when executed by the processor, direct the computing device to: receive, at a management system on a payment network, a provider string associated with a provider identification and comprising a provider score with respect to activity of a provider on a second network, wherein the second network is a separate network from the payment network;
extract, from the provider string, the provider identification;
determine, in view of the provider identification, a potential merchant identification code from a set of known merchant identification codes within the payment network that corresponds to the provider;
analyze transaction data stored in a structured data resource associated with the management system to identify at least one transaction associated with the potential merchant identification code;
assign, in view of the provider score of the provider used to determine the potential merchant identification code, a transaction score to each transaction associated with the potential merchant identification code to incorporate the provider score with respect to the activity of the provider on the second network;
store the transaction score;
determine merchant statistics by analyzing the at least one transaction;
generate a report in view of the merchant statistics and the transaction score which incorporates the provider score with respect to the activity of the provider on the second network with transaction data on the payment network; and
provide, for display via a graphical user interface, the report.

15. The computing device of claim 14, wherein the provider string is a vector comprising the provider identification, the provider score, and a set of related provider-level data.

16. The computing device of claim 14, wherein a plurality of provider strings is arranged in tuples in comma-separated values format in the structured data resource.

17. The computing device of claim 16, further comprising instructions that direct the computing device to: use at least one of string and natural language processing techniques, or error-correcting techniques to determine the potential merchant identification code from the set of known merchant identification codes.

18. The computing device of claim 14, wherein the transaction data comprises at least one of a plurality of merchant identification codes, a plurality of masked card numbers, or a plurality of payment methods.

19. The computing device of claim 14, wherein the merchant statistics comprise at least one of an average spend variance associated with the potential merchant identification code, generated sales, projected sales, or a number of distinct cards and/or types of payments accepted by a merchant associated with the potential merchant identification code.

20. The computing device of claim 16, wherein the provider string is received from a blockchain risk provider.

21. The method of claim 1, wherein determining, in view of the provider identification, the potential merchant identification code from a set of known merchant identification codes within the payment network that corresponds to the provider comprises using a distance function to match the provider identification with the potential merchant identification code.

22. The method of claim 1, wherein determining merchant statistics by analyzing the at least one transaction comprises isolating the transactions to, from, or through the potential merchant identification code over a specific set of time windows, and further comprises producing a set of transactions T_X=[t1, t2, . . . tW], wherein tk (k=1 to W) is an individual transaction associated with the potential merchant identification code.

23. The method of claim 1, wherein determining the merchant statistics by analyzing the at least one transaction comprises analyzing inbound transactions of an acquirer, the inbound transactions being obtained from the transaction data stored in the structured data resource and comprising the at least one transaction associated with the potential merchant identification code and having the assigned transaction score; and
wherein generating the report comprises generating, for the acquirer, an acquirer report comprising, for a merchant associated with the potential merchant identification code, merchant statistics of overall transaction score, average spending variance, sales, and number of distinct cards accepted.
